(19) United States
(12) Patent Application Publication
(10) Pub. No.: US 2003/0214573 A1
(43) Pub. Date: Nov. 20, 2003

(54) Dual-purpose videophone for internet and public switched telephone network (PSTN)

(76) Inventor: Song Rok Oh, Seoul (KR)

Correspondence Address: HARNESS, DICKEY & PIERCE, P.L.C., P.O. BOX 828, BLOOMFIELD HILLS, MI, 48303, US

(21) Appl. No.: 10/321,927

(22) Filed: Dec. 17, 2002

(30) Foreign Application Priority Data
May 17, 2002 (KR) 2002-27410

(51) Int. Cl. H04N 7/14

(52) U.S. Cl. 348/14.01; 348/14.03

(57) ABSTRACT

The present invention relates to a dual-purpose videophone applicable for both Internet and PSTN by handling both IP and PSTN in a single unit.

The present invention presents a dual-purpose videophone for Internet and PSTN, characterized by comprising: a first means, equipped with a modem for being connected to PSTN, for carrying out H.324 protocol and V.84/V.80 protocol; a second means, equipped with an ethernet for being connected to Internet, for carrying out H.323 protocol and TCP/IP protocol; and a selection means for selecting one means from the first means and the second means.

A dual-purpose videophone of the present invention can handle both IP and PSTN in a single unit, and thereby provide a video-communication capability regardless of the network types and the residence localities, eliminate the economical burden to purchase an extra videophone, and enable an interlocking system construction.

### BACKGROUND OF THE INVENTION

1. Field of the Invention

The present invention relates to a dual-purpose videophone for Internet and public switched telephone network (PSTN). In more detail, it relates to a videophone applicable for both Internet and PSTN by handling both IP and PSTN in a single unit.

1. Description of the Related Art

In the prior art, videophones, with which one can talk to the other party with seeing his (or her) face, were separately produced and marketed to be a videophone for Internet using an IP of Internet or a videophone for PSTN using PSTN.

A video communication using Internet was being carried out by using a computer, equipped with a videophone for Internet or a camera, between Internet service providers (ISPs) connected on Internet, and a video communication using PSTN was being carried out by using a videophone for PSTN between switching systems connected on PSTN.

Therefore, video communication was possible only between videophones using the same kind of network, and the usability has been limited according to the network type and the locality.

For example, a person living in a remote and secluded locality could not use a videophone for Internet since Internet does not cover the locality. And in case of installing an Internet line for that kind of locality, it requires a large amount of installation expense.

In addition, if using a videophone for PSTN in a city, it costs more than the case of using a videophone for Internet.

A prior application for Korean Patent (application number: 2000-51750) discloses a video communication system using a general telephone and a business method using the system. It relates to a business model that makes a videophone with an extremely low price by connecting a general home-telephone to a personal computer (PC), provides it to a user for free, receives a certain amount of using fee by month, and uses the background screen of a videophone as an advertisement screen to produce an additional profit.

According to the prior application described above, it connects a general telephone to a PC, and thus it enables interlocking between a telephone and a videophone and a videophone and a videophone as well as a telephone and a telephone. Therefore, it can provide a perfect interlocking system with a conventional home-telephone.

In addition, since the price required to install the system is extremely low as described above, a provider can distribute the systems to users for free and receive only a certain amount of using fee by month. And thus, a user can install and use a videophone immediately without buying a conventional high-price videophone.

However, the prior art described above has disadvantages that: a user have to pay a certain amount of monthly using fee, which becomes an economical burden; a user have to own a PC to which a telephone is to be connected; and a user registration is being required, and thus an unnecessary identification process is being required and the user information may be effused through the process.

Besides, if the background screen of a videophone becomes to be an advertisement screen, it could cause a negative response for using the videophone for users not willing to watch an advertisement.

### SUMMARY OF THE INVENTION

The present invention is proposed to solve the problems of the prior art mentioned above. It is therefore the object of the present invention to provide a dual-purpose videophone for Internet and PSTN that can handle both IP and PSTN in a single unit, and thereby provide a video-communication capability regardless of the network types and the residence localities, eliminate the economical burden to purchase an extra videophone, and enable an interlocking system construction.

It is another object of the present invention to provide a dual-purpose videophone for Internet and PSTN that can handle both IP and PSTN in a single unit, and thereby reduce the connection time required for local/international usage by using IP where it is available, and use the conventional PSTN in a remote and secluded locality instead of installing a new Internet line to avoid the economical inefficiency.

It is yet another object of the present invention to provide a dual-purpose videophone for Internet and PSTN that can provide a relatively cheap videophone to a user since the using fee for Internet is comparatively lower than that of PSTN in view of time and distance base.

To achieve the object mentioned above, the present invention presents a dual-purpose videophone for Internet and PSTN, with which one can talk to the other party with seeing his (or her) face, characterized by comprising: a first means, equipped with a modem for being connected to PSTN, for carrying out H.324 protocol and V.84/V.80 protocol; a second means, equipped with an ethernet for being connected to Internet, for carrying out H.323 protocol and TCP/IP (Transmission Control Protocol/Internet Protocol) protocol; and a selection means for selecting one means from the first means and the second means.

### BRIEF DESCRIPTION OF THE DRAWINGS

FIG. 1′ is a conceptual diagram of a service network using a videophone in accordance with the present invention.

FIG. 2 is a view illustrating the protocol of a videophone in accordance with the present invention.

FIG. 3 is a view illustrating the hardware structure of a videophone in accordance with the present invention.

FIG. 4 is a view illustrating a line (network type) selection stage of a videophone in accordance with the present invention.

FIG. 5 is a view illustrating the transmission and reception algorithms of a videophone in accordance with the present invention in case of using H.323 protocol.

FIG. 6 is a view illustrating the transmission algorithm of a videophone in accordance with the present invention in case of using H.324 protocol.

FIG. 7 is a view illustrating a backside structure of an embodiment of a videophone in accordance with the present invention.

### DETAILED DESCRIPTION OF THE EMBODIMENTS

Hereinafter, referring to appended drawings, the structure and operation principles of an embodiment of the present invention are described in detail.

FIG. 1 is a conceptual diagram of a service network using a videophone in accordance with the present invention.

As described in the figure, a dual-purpose videophone (1) in accordance with the present invention is connected to another videophone for PSTN (6) or a conventional telephone through PSTN (3) via switching system (2) to carry out a voice communication and/or a video communication between users.

With this structure, the videophone (1) can be used even in a remote and secluded locality where Internet line is not yet installed and in specific places such as military and/or security facilities where Internet line is not installed.

A dual-purpose videophone (1) can also be connected to another videophone for Internet (7), a telephone for Internet, or a computer (8) being connected to a camera through Internet (5) via an ISP (4) to carry out a voice communication and/or a video communication.

With this structure, a user can have an immediate local/international video communication, wherever Internet is being installed, owing to the fast transmission capability through Internet. Moreover, by using Internet whose network-using fee is much cheaper than that of PSTN, it reduces user's economic burden.

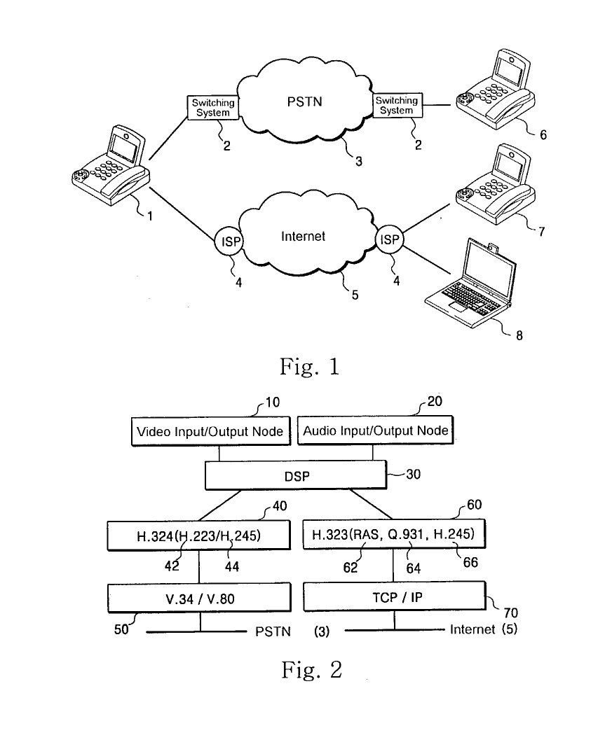

FIG. 2 is a view illustrating the protocol of a dual-purpose videophone (1) described above. Looking into FIG. 2, it carries out a digital signal processing for video and audio signals, inputted through a video input/output node (10) and an audio input/output node (20), at a digital signal processor (DSP; 30), and performs different protocols according to the corresponding network type of PSTN (3) or Internet (5).

That is to say, it carries out H.324 (40) protocol and V.34/V.80 (50) protocol for the case of using PSTN (3) and H.323 (60) protocol and TCP/IP (70) for the case of using Internet (5).

Similarly, it performs different protocols for video and audio signals inputted through PSTN (3) or Internet (5) according to the network type, carries out a digital signal processing on them at DSP (30), and outputs them through a video input/output node (10) and an audio input/output node (20).

Audio and video signals can be transmitted through either Internet (5) or PSTN (3) by user's selection.

However, since the incoming signals can be received through either Internet (5) or PSTN (3), a user can not preset a reception mode.

Therefore, the reception system is always being in stand-by mode, and as shown in FIG. 3, through the analyses on H.324 (40) protocol and H.323 (60) protocol, it can be noticed whether the data is received by a modem (94) or an ethernet (96).

H.324 (40) protocol, described in FIG. 2, is an ITUT (International Telecommunication Union: Telecommunication Standardization Sector) recommendation on telecommunication of voice, moving picture and data on a general PSTN (3), and it necessarily requires a modem control (V.34), a multiple partitioning method for multimedia data (H.223; 42), and a system control (H.245; 44).

H.223 (42) also provides channels for file transmission and sharing/exchanging the data like a white board.

V.34/V.80 (50) protocol is a kind of V.xx telephone network standards, a V-series recommendation of ITU-T. V.34 provides a transmission speed of 28800 bps, however, the speed can be lowered to 24000 bps, 19200 bps, and so on. V.80 provides a transmission speed of 28800 bps or higher.

H.323 (60) protocol is an ITU-T standard for transmitting multimedia video-conference data through a packet-exchange-type network like TCP/IP (60) protocol.

H.323 (60) protocol includes RAS (Registration Admission Status; 62) for regulating the registration, admission and status of endpoint requesting for a call signal to a gatekeeper; Q.931 (64), an ITU-T recommendation for regulating call setting procedures of D channel in an ISDN user-network interface (UNI), for controlling the control procedures of messages or basic calls being exchanged between a user and a network for setting, maintaining and disengaging a transmission route between a transmitting user and a receiving user; and H.245 (66) for compensating an available bandwidth or functions between terminals and carrying out a session control function for a multiple-user communication.

TCP/IP (70) is a basic communication protocol of Internet, and it is also used in private networks such as an intranet or an extranet.

A TCP/IP program is installed when a user sets up his (or her) computer to connect Internet (5), and through this a user can send/receive messages or information to/from another user using the same TCP/IP protocol.

TCP/IP is a program composed of two classes.

The upper class, TCP, is in charge of partitioning a message or a file into smaller packets, transmitting them through Internet, and restoring the received packets into the original message.

The lower class, IP, is in charge of processing the address parts of the packets so that the packets can be accurately transmitted to their destinations.

Each gateway on a network checks the address of a message for acknowledging the destination where the message is to be transmitted.

In case of a message being partitioned into numbers of packets, the packets may be transmitted through different routes from one another, but restored together in the final destination.

FIG. 3 is a view illustrating the hardware structure of a dual-purpose videophone in accordance with the present invention.

A camera (82) takes a picture of a user and sends it to a CPU (86) as a video signal.

A CPU (86) processes video-related data, compresses/restores audio signals, and controls a modem (94) or an ethernet (96).

In addition, it also controls video signals outputted from a camera (82) containing external video signals and video signals outputted to a liquid crystal display (LCD; 88) and displayed thereon.

An LCD (88) is a device for displaying the signals received from a CPU (86), and it is applicable for both analog video signals (NTSC/PAL) and digital signals.

A keypad (90) is a means for inputting phone-numbers, characters, etc., and a memory (84) stores necessary data.

A modem (94) is for carrying out a video/audio communication on a general PSTN (3), and it converts the digital video/audio signals, to be outputted to an external PSTN (3), to analog signals and converts the analog video/audio signals, inputted from an external PSTN (3), to digital signals.

An ethernet (96) is a local area network (LAN) for video/audio communication with Internet (5), and it exchanges the information between maximum of 1,024 data stations with a transmission speed of 10 Mbps within about 2.5 Km distance between data stations.

Thus, the easier connection and the faster transmission speed can be obtained compared with the case of using PSTN (3).

A caller information display (CID) section (98) is a section for displaying a caller information on LCD (88), and more particularly, it is for displaying a caller information, when one network is in use, incoming through the other network.

In other words, a caller information incoming through PSTN (3) during a voice/video communication through Internet (5) or a caller information incoming through Internet (5) during a voice/video communication through PSTN (3) can be displayed on CID section (98).

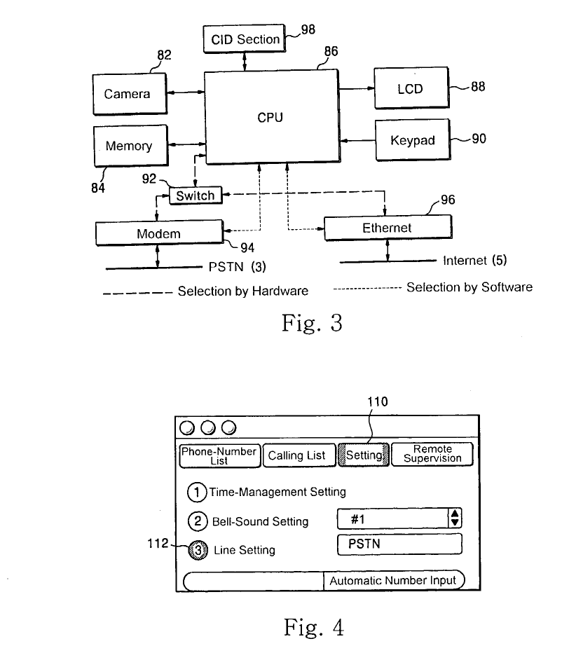

A user has to select either Internet (5) or PSTN (3) for transmission. For selecting a network type, a user can choose either Internet (S) or PSTN (3) by line-setting (112) on a setting menu (110) as described in FIG. 4.

Referring to FIG. 3, either a modem (94) line or an ethernet (96) line, inputted to a CPU (86), can be selected by using hardware, a switch (92).

If using a general port of a CPU (96), this selection can also be fulfilled using software.

According to the selection of a network, it is decided that which one will be used between a modem (94) or an ethernet (96) and thereby a PSTN telephone number or an IP address will be inputted.

In case that Internet (5) is being selected, an ethernet (96) is connected to Internet (5) and thereby connected to another videophone (7) for Internet or a net-meeting of a computer (8), and a voice/video communication is being carried out thereafter.

In case that PSTN (3) is being selected, a modem (92) is connected to PSTN (3) and thereby connected to another videophone (6) for PSTN or a general telephone, and a voice/video communication is being carried out thereafter.

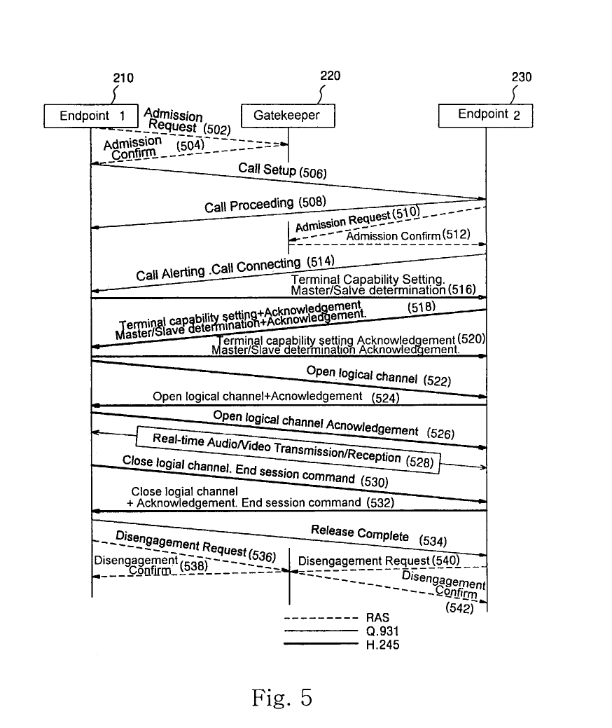

In case of Internet (5) being selected, the transmission and reception algorithms are described in FIG. 5. H.323 (60) protocol is in charge of carrying out these procedures.

FIG. 5 is a view illustrating the transmission and reception algorithms of a dual-purpose videophone in accordance with the present invention in case of using H.323 protocol.

The endpoints (210, 230) represent devices that are capable of communicating with each other by audio/video signals and data in a one-to-one communication or in a net-meeting. Here, an endpoint1 (210) represents a transmission point and an endpoint2 (230) represents a reception point.

These endpoints (210, 230) can communicate bi-directionally with a gatekeeper (220) or the other endpoints (230, 210).

A gatekeeper (220) is a device for carrying out an address conversion and an access control to H.323 endpoint. It also carries out a bandwidth management.

A gatekeeper (220) contains the information on IP, and thus it helps a user to replace an IP address with a simple number.

An RAS (62) protocol is a protocol only used for the case of a gatekeeper (220) being existed, and it provides the functions of registration, admission, and status of an endpoint (210 or 230) that requests a call signal to a gatekeeper (220).

An endpoint (210 or 230) has to go through a registration request (RRQ) process at a gatekeeper (220) for being connected to the other endpoint (230 or 210), and after the process, it receives an admission to connect to the other endpoint.

On the other hand, for the case of disengaging a connection, it has to go through a disengagement request (DRQ) process.

Q.931 (64) protocol is a protocol used for a call setup. In case that an RRQ process at a gatekeeper (220) is normally carried out, each endpoint (210 or 230) sends a message for requesting a call connection to the other endpoint (230 or 210).

In H.323 (60), H.245 (66) protocol is used for a call control.

H.245 (66) is a protocol describing the contents (capability exchange, open logical channel, etc.) of call control. When a call setup is achieved, the endpoints (210, 230), connected to each other, transmit voice and video signals through numbers of channels.

Referring to FIG. 5, these procedures will be described in detail hereinafter.

When a user selects Internet (S), TCP/IP (70) opens the channel between endpoint1 (210) and a gatekeeper (220). When they are connected, endpoint1 (210) requests an admission (502) to the gatekeeper (220) by RAS (62) protocol, and the gatekeeper (220) confirms an admission (504) to endpoint1 (210).

Then, endpoint1 (210) sends a message (506) for call setup to endpoint2 (230) by Q.931 (64) protocol, and endpoint2 (230) sends a message (508) for call processing to endpoint1 (210).

Then, endpoint2 (230) requests an admission (510) to the gatekeeper (220) by RAS (62) protocol, and the gatekeeper (220) confirms an admission (512) to endpoint2 (230).

After the admission is confirmed, endpoint2 (230) sends (514) messages of call alerting and call connecting in sequence to endpoint1 (210) by Q.931 (64) protocol.

A call setup process is achieved through the procedures described above.

In other words, RAS (62) protocol and Q.931 (64) protocol take charge in call setup process between endpoints (210, 230) and a gatekeeper (220).

After a call setup process is completed, H.245 (66) protocol takes charge for adjusting bandwidth and CODECs for audio/video signals.

Then, endpoint1 (210) sends (516) messages on terminal capability setting and master/slave determination to endpoint2 (230), and endpoint2 (230) sends (518) the messages, with adding an acknowledgement message to each of the two messages respectively, to endpoint1 (210).

Then, endpoint1 (210) sends (520) messages of terminal capability setting acknowledgement and master/slave determination acknowledgement to endpoint2 (230).

Next, endpoint1 (210) sends (522) a message of open logical channel to endpoint2 (230), and endpoint2 (230) sends (524) the message, with adding an acknowledgement message thereto, to endpoint1 (210).

Then, endpoint1 (210) sends (526) a message of open logical channel acknowledgement to endpoint2 (230).

When a call control between an endpoint1 (210) and an endpoint2 (230) is being achieved by following the procedures as described above, video signals and/or audio signals are being transmitted/received in a real-time base between endpoint1 (210) and endpoint2 (230), and thereby a voice communication and/or a video communication through Internet (5) is accomplished (528).

When communication is completed, endpoint1 (210) sends (530) messages of close logical channel and end session command to endpoint2 (230), and endpoint2 (230) sends (532) a message of close logical channel, with adding an acknowledgement message thereto, and a message of end session command to endpoint1 (210).

Then, endpoint1 (210) sends (534) a message of release complete to endpoint2 (230), and the overall transmission/reception between endpoint1 (210) and endpoint2 (230) is completed.

After the communication is completed, endpoint1 (210) and endpoint2 (230) request for disengagement (536, 540) to the gatekeeper (220) by RAS (62) protocol, and the gatekeeper (220) sends disengagement confirms (538, 542) to endpoint1 (210) and endpoint2 (230).

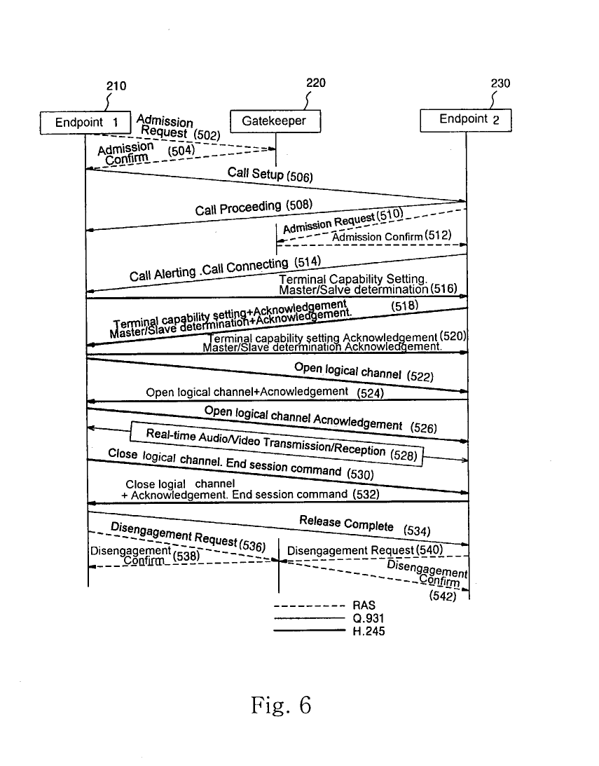

FIG. 6 illustrates a protocol structure at a transmission side in case that a user selects PSTN.

When a user picks up a phone to make a phone-call through PSTN (3), a switching system (2) sends a dial tone to the user and receives a number from the user. With a number being inputted, the switching system (2) tries to access to the other party's phone.

If a response is received from the other party's phone, they are connected to each other and get into a voice-communication state.

Here, if pressing a video-access button for video access, it tries to perform a video communication. Then, each party sets up a data channel for a video communication between each other by using V.34/V/80 (50) equipped in a modem (94).

When a data channel is being setup, both parties adjust audio and video CODECs for each other by using H.245 (44) of H.324 (40).

After audio and video CODECs are decided through the process described above, a video communication is being carried out.

At this stage, video signals are transmitted by H.263 (46) of H.324 and audio signals are transmitted by G.723.1 (48) of H. 324.

Here, for increasing the transmission efficiency, multiplexing is being carried out by using H.223 (42) of H.324.

Then, audio and video data is being transmitted/received between each other, and thus an audio/video communication is being accomplished.

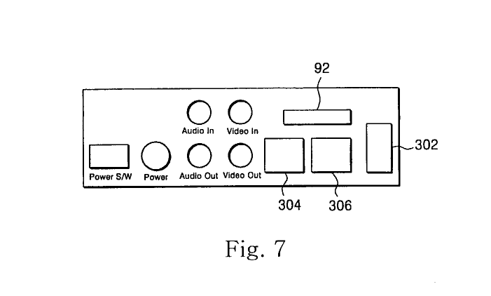

FIG. 7 is a view illustrating a backside structure of an embodiment of a videophone in accordance with the present invention.

The first access node (302) is for an audio and/or a video communication through PSTN (3) by being connected to an external PSTN.

The second access node (304) is for an audio and/or a video communication through Internet (5) by being connected to an external Internet line.

Here, if a dual-purpose videophone is only and exclusively connected to an external Internet line, a computer or a PDA (Personal Digital Assistant) can not use the Internet line. Thus in this case, by installing a hub in a dual-purpose videophone, connecting the third access node (306) to the hub, and connecting a computer or a PDA to the third access node, a user can use Internet on a computer or a PDA while a videophone is not using the Internet line.

A switch (92) is the same as the switch (92) described in FIG. 3, and it is used for network selection of Internet or PSTN in case that the selection is performed by hardware.

As mentioned thereinbefore, the present invention provides a dual-purpose videophone embodying a videophone for Internet and a videophone for PSTN in a single unit by enabling to handle both IP and PSTN in a single unit. Thus, it provides an overall efficiency improvement for users in time, space, and expenses.

In addition, it is applicable for a prior conventional videophone for Internet connected to a cable modem, an asymmetric digital subscriber line (ADSL), or a home LAN. And thus a user, being connected to Internet by a cable modem, an ADSL, or a home LAN, can use both Internet and PSTN at the same time.

Besides, since a caller information is being displayed when a phone-call is incoming through PSTN while using a phone through Internet or vice versa, a user can use a videophone conveniently on either Internet or PSTN.

Since those having ordinary knowledge and skill in the art of the present invention will recognize additional modifications and applications within the scope thereof, the present invention is not limited to the embodiments and drawings described above.

What is claimed is:

1. A dual-purpose videophone for Internet and PSTN, with which one can talk to the other party with seeing his (or her) face, characterized by comprising:
a first means, equipped with a modem for being connected to PSTN, for carrying out H.324 protocol and V.84/V.80 protocol;
a second means, equipped with an ethernet for being connected to Internet, for carrying out H.323 protocol and TCP/IP (Transmission Control Protocol/Internet Protocol) protocol; and
a selection means for selecting one means from said first means and said second means.

2. A dual-purpose videophone for Internet and PSTN as claimed in claim 1,
wherein said selection means is constituted by program so that the network selection of PSTN or Internet can be carried out by line-selection on a setting menu.

3. A dual-purpose videophone for Internet and PSTN as claimed in claim 1,
wherein said selection means is constituted by hardware, a switch, so that the network selection of PSTN or Internet can be carried out by said switch.

4. A dual-purpose videophone for Internet and PSTN as claimed in claim 1,
characterized by further comprising a caller information display (CID) section for displaying a caller information in case that a phone-call is incoming through one network line among PSTN and Internet while a user is having a communication using the other network line.

5. A dual-purpose videophone for Internet and PSTN as claimed in claim 1,
characterized in that a hub is installed in said dual-purpose videophone, an access node is connected to said hub, and a peripheral device such as a computer or a PDA is connected to said access node so that a user can use Internet on said peripheral device while said videophone is not using the Internet line.
